(19) United States
(12) Patent Application Publication
(10) Pub. No.: US 2017/0327713 A1
(43) Pub. Date: Nov. 16, 2017

(54) ONE-COMPONENT, CURABLE SILICONE COMPOSITION THAT IS STABLE IN STORAGE

(71) Applicant: ELANTAS GMBH, Wesel (DE)

(72) Inventors: Andreas STEINMANN, Hamburg (DE); Kim Bastian BEBENROTH, Hamburg (DE); Jochen BAUMANN, Wentorf (DE); Gerold SCHMIDT, Hamburg (DE)

(21) Appl. No.: 15/527,973

(22) PCT Filed: Nov. 20, 2015
(86) PCT No.: PCT/EP2015/077179

§ 371 Date: May 18, 2017

(30) Foreign Application Priority Data
Nov. 21, 2014 (DE) 10 2014 223 827.7

(51) Int. Cl. C09D 183/06; C08K 5/5425; C08K 5/524; C08K 5/56; C08K 3/26

(52) U.S. Cl. CPC C09D 183/06; C08K 5/56; C08K 3/26; C08K 5/524; C08K 5/5425

(57) ABSTRACT

The invention relates to a composition containing a) 30 to 99.799989 wt % of at least one linear or branched polyorganosiloxane, containing at least two alkenyl or alkinyl groups, as component A; b) 0.1 to 30 wt % of at least one linear or branched polyorganosiloxane containing at least 3 Si—H groups, as component B; c) 0.000001 to 1 wt % of a hydrosilylation catalyst chosen from the group comprising the platinum-1, 3-divinyl-1,1, 3, 3-tetramethyl disiloxane complex (Karstedt complex), the platinum-1,3-diallyl-1,1,3,3-tetramethyldisiloxane complex, the platinum-1,3-divinyl-1,3-dimethyl-1,3-diphenyldisiloxane complex, the platinum-1,1,3,3-tetraphenyl-disiloxane complex, and the platinum-1,3,5,7-tetramethyl-1,3,5,7-tetravinylcyclotetrasiloxane complex, as component C; d) 0.00001 to 5 wt % of tris(2,4-di-tert.-butylphenyl) phosphite, as component D; e) 0 to 69.899989 wt % of at least one possibly coated filler as component E; f) 0 to 69.899989 wt % of one or more linear or branched polyorganosiloxanes, containing two terminal Si—H groups or one terminal Si—H group and one terminal alkenyl group, as component F; g) 0 to 69.799989 wt % of one or more further linear or branched polyorganosiloxanes as component G; h) 0 to 10 wt % of one or more additives as component H; wherein the sum of the components A to H yields 100 wt %.

The invention relates to compositions comprising polyorganosiloxanes, a hydrosilylation catalyst, an inhibitor and optionally a filler, use of these for the application of protective coatings onto an electrical or electronic component or device, and also the coated components per se.

The invention relates to the field of silicone compositions which can be crosslinked by hydrosilylation, serving for the protection of electronic components from moisture and soiling, and also for the prevention of short circuits. It has long been known that silicone compositions crosslinkable by hydrosilylation can be used for this purpose. These comprise at least one alkenyl-group-containing polyorgano-siloxane, e.g. a vinyl-group-terminated polydimethylsiloxane, and also a poly-organohydrosiloxane, these being crosslinked in the presence of a hydrosilylation catalyst.

Silicone formulations which comprise the components mentioned can normally be stored for a prolonged period only if they are stored in the form of two separate mixtures, of which one component comprises the polyorganohydrosiloxane and the other component comprises the hydrosilylation catalyst. Before crosslinking, the two components have to be thoroughly mixed with one another. In the field of industry, care has to be taken here to comply with the required mixing ratio, and to avoid any concomitant stirring of air bubbles into the mixture. A mixing apparatus is moreover needed. There is also the risk that in the event of a production stoppage the silicone formulation remains in the mixing apparatus, where it crosslinks and thus blocks the apparatus. Single-component silicone formulations are being used in an attempt to eliminate these disadvantages.

In single-component silicone formulations the reactivity of the hydrosilylation catalyst prior to use is reversibly inhibited, for example via addition of nitrogen or sulphur-containing compounds. It is also known that platinum-phosphite complexes can be used as hydrosilylation catalysts.

EP 2 050 768 A1 describes a curable silicone composition made of an organic or organosilicon compound having aliphatic carbon-carbon multiple bonds (A), an organosilicon compound having at least two Si-bonded hydrogen atoms (B), an organosilicon compound having Si-bonded moieties having aliphatic carbon-carbon multiple bonds and Si-bonded hydrogen atoms (C), and a platinum-phosphite complex (D) as crosslinking catalyst in which platinum is present in the oxidation state +2. The catalyst is synthesized via reaction of a platinum salt, for example platinum dichloride, with a phosphite.

U.S. Pat. No. 6,706,840 describes a curable siloxane composition made of an epoxy olefin (A), an organohydrosiloxane (B), and a platinum-phosphite complex (C) as crosslinking catalyst. The platinum here is present in the oxidation state +2.

U.S. Pat. No. 4,256,616 describes a curable siloxane composition made of a vinylorganopolysiloxane (A), a polyorganohydrosiloxane (B), a platinum-phosphite complex (C), where platinum is present in the oxidation state 0, and a tin salt (D). Tin salts are generally hazardous to health.

U.S. Pat. No. 4,329,275 describes a heat-curing polysiloxane composition made of a polyorganosiloxane having vinyl groups (A), a polyorganohydrosiloxane (B), a platinum compound (C), a phosphorus compound (D), and an organic peroxide (E) which comprises no hydroperoxide groups. There is no mention of tris(2,4-di-tert-butylphenyl) phosphite.

DE 603 16 102 T2 describes a single-component organopolysiloxane gel composition made of a branched, vinyl-group-containing polyorganosiloxane (A), a polyorganohydrosiloxane (B), a platinum catalyst (C), a phosphite triester (D), and an organic peroxide (E). Tris(2,4-di-tert-butylphenyl) phosphite is mentioned inter alia. The quantity of the organic peroxide present is at least 2 equivalents, based on the phosphite triester.

B. Marciniec et al., Applied Catalysis A: General 362 (2009) 106-114, Effect of triorganophosphites on platinum catalyzed curing of silicon rubber, describe the synthesis of various platinum-phosphite complexes, and compare their reactivities in hydrosilylation.

It is an object of the invention to provide a single-component, addition-crosslinking silicone composition which has very good stability in storage at room temperature, and which crosslinks rapidly when heated.

The object is achieved via a composition comprising
a) from 30 to 99.799989% by weight of at least one linear or branched polyorganosiloxane comprising at least two alkenyl or alkynyl groups, as component A;
b) from 0.1 to 30% by weight of at least one linear or branched polyorganosiloxane comprising at least 3 Si—H groups, as component B;
c) from 0.000001 to 1% by weight of a hydrosilylation catalyst selected from the group consisting of the platinum-1,3-divinyl-1,1,3,3-tetramethyldisiloxane complex (Karstedt complex), the platinum-1,3-diallyl-1,1,3,3-tetramethyl-disiloxane complex, the platinum-1,3-divinyl-1,3-dimethyl-1,3-diphenyl-disiloxane complex, the platinum-1,1,3,3-tetraphenyldisiloxane complex, and the platinum-1,3,5,7-tetramethyl-1,3,5,7-tetravinylcyclotetrasiloxane complex, as component C;
d) from 0.00001 to 5% by weight of tris(2,4-di-tert-butylphenyl) phosphite as component D;
e) from 0 to 69.899989% by weight of at least one optionally coated inorganic filler as component E,
f) from 0 to 69.899989% by weight of one or more linear or branched poly-organosiloxanes comprising two terminal Si—H groups or one terminal Si—H group and one terminal alkenyl group, as component F;
g) from 0 to 69.899989% by weight of one or more other linear or branched polyorganosiloxanes as component G;
h) from 0 to 10% by weight of one or more additives as component H;

where the entirety of components A to H gives 100% by weight.

Surprisingly, it has been found that addition of tris(2,4-di-tert-butyl) phosphite to a curable silicone composition which can be crosslinked by hydrosilylation and comprises, as platinum catalyst, platinum-1,3-divinyl-1,1,3,3-tetramethyldisiloxane complex (Karstedt complex), platinum-1,3-diallyl-1,1,3,3-tetramethyldisiloxane complex, platinum-1,3-divinyl-1,3-dimethyl-1,3-diphenyldisiloxane complex, platinum-1,1,3,3-tetraphenyldisiloxane complex or platinum-1,3,5,7-tetramethyl-1,3,5,7-tetravinylcyclotetrasiloxane complex durably inhibits the platinum catalyst, thus achieving stability of a number of months in storage at room temperature. If the composition is heated, the phosphite is oxidized by oxygen and thus loses its inhibiting effect. The platinum catalyst is thus activated, and the silicone composition hardens.

The formulation of the invention for a curable silicone composition is a catalytically vulcanizable mixture. It comprises a polyorganosiloxane having at least two alkenyl or alkynyl groups (component A), a polyorganosiloxane having at least 3 Si—H-units (component B), the catalyst for hydrosilylation (component C), preferably the Karstedt complex, tris(2,4-di-tert-butylphenyl) phosphite (component D; CAS number 31570-04-4), optionally an inorganic filler such as dolomite, powdered quartz, or optionally coated fumed silica (component E), and also optionally other auxiliaries and additives (component H), for example auxiliaries for colouring, for improving fire performance, for improving adhesion, or for influencing flow behaviour.

The composition of the invention comprises no tin salts and no peroxides.

In one specific variant, the formulation moreover comprises a dihydropolyorganosiloxane (component F). In other specific variants, the formulation comprises a dimethylpolyorganosiloxane (component G) or a monovinylmonohydrosiloxane (component G).

The person skilled in the art is aware of methods that can be used to reduce the reactivity by way of example of the Karstedt complex, e.g. by adding nitrogen- or sulphur-containing compounds. It is also known that platinum-phosphite complexes can be used. In contrast, a single-component formulation which is stable in storage for a number of months at room temperature but curable in a few minutes when heated is novel.

Surprisingly, it has been found that addition of tris(2,4-di-tertbutylphenyl) phosphite leads to formulations that are stable in storage at room temperature and harden in a few minutes when heated, even without any concomitant use of additions such as organic peroxides or tin salts.

Tin salts have the disadvantage of being hazardous to health especially during the production of the formulation. They are moreover not transparent, and therefore can give only non-transparent formulations.

Organoperoxides can have a disadvantageous effect on stability in storage, since they can decompose slowly even without exposure to heat, and thus lose their function. When heated they can moreover not only oxidize the phosphite but also crosslink the siloxane constituents to one another by a free-radical route. The degree of crosslinking is thus impossible to control, and product parameters of the hardened formulation, for example hardness and elasticity, are subject to large variations.

One preferred embodiment of the composition of the invention comprises

a) from 50 to 99.69899% by weight of component A;

b) from 0.2 to 15% by weight of component B;

c) from 0.000001 to 1% by weight of component C;

d) from 0.001 to 0.5% by weight of component D;

e) from 0.1 to 49.798999% by weight of component E;

f) from 0 to 49.69899% by weight of component F;

g) from 0 to 49.69899% by weight of component G;

h) from 0 to 10% by weight of component H;

where the entirety of components A to H gives 100% by weight.

One embodiment of the composition of the invention comprises

a) from 80 to 99.5899% by weight of component A;

b) from 0.2 to 10% by weight of component B;

c) from 0.0001 to 0.5% by weight of component C;

d) from 0.01 to 2% by weight of component D;

e) from 0.2 to 19.7899% by weight of component E;

f) from 0 to 19.5899% by weight of component F;

g) from 0 to 19.5899% by weight of component G;

h) from 0 to 10% by weight of component H;

where the entirety of components A to H gives 100% by weight.

One preferred embodiment of the composition of the invention is composed of components A, B, C, D and optionally E and optionally H, where the entirety of components A to E and H gives 100% by weight. Another preferred embodiment of the composition of the invention is composed of components A, B, C, D, optionally E, G and optionally H, where the entirety of components A to E, G and H gives 100% by weight. Another preferred embodiment of the composition of the invention is composed of components A, B, C, D, optionally E, F, G and optionally H, where the entirety of components A to G gives 100% by weight.

One preferred embodiment of the composition of the invention comprises

a) from 71 to 99.69899% by weight of component A;

b) from 0.2 to 15% by weight of component B;

c) from 0.00001 to 1% by weight of component C;

d) from 0.001 to 3% by weight of component D;

e) from 0.1 to 28.79899% by weight of component E;

f) from 0 to 28.69899% by weight of component F;

g) from 0 to 28.69899% by weight of component G;

h) from 0 to 10% by weight of component H;

where the entirety of components A to H gives 100% by weight.

Another embodiment of the composition of the invention comprises

a) from 82.5 to 99.5899% by weight of component A;

b) from 0.2 to 10% by weight of component B;

c) from 0.0001 to 0.5% by weight of component C;

d) from 0.01 to 2% by weight of component D;

e) from 0 to 17.2899% by weight of component E;

f) from 0 to 17.2899% by weight of component F;

g) from 0 to 17.2899% by weight of component G;

h) from 0 to 10% by weight of component H;

where the entirety of components A to H gives 100% by weight.

Another embodiment of the composition of the invention comprises

a) from 30 to 99.798989% by weight of component A;

b) from 0.1 to 30% by weight of component B;

c) from 0.000001 to 1% by weight of component C;

d) from 0.00001 to 5% by weight of component D;

e) from 0.1 to 69.898989% by weight of component E;

f) from 0.001 to 69.799989% by weight of component F;

g) from 0 to 69.798989% by weight of component G;

h) from 0 to 10% by weight of component H;

where the entirety of components A to H gives 100% by weight.

Another embodiment of the composition of the invention comprises

a) from 30 to 99.798989% by weight of component A;

b) from 0.1 to 30% by weight of component B;

c) from 0.000001 to 1% by weight of component C;

d) from 0.00001 to 5% by weight of component D;

e) from 0.1 to 69.898989% by weight of component E;

f) from 0 to 69.798989% by weight of component F;

g) from 0.001 to 69.799989% by weight of component G;

h) from 0 to 10% by weight of component H;

where the entirety of components A to H gives 100% by weight.

Another embodiment of the composition of the invention comprises

a) from 30 to 99.797989% by weight of component A;

b) from 0.1 to 30% by weight of component B;

c) from 0.000001 to 1% by weight of component C;

d) from 0.00001 to 5% by weight of component D;

e) from 0.1 to 69.897989% by weight of component E;

f) from 0.001 to 69.798989% by weight of component F;

g) from 0.001 to 69.798989% by weight of component G;

h) from 0 to 10% by weight of component H;

where the entirety of components A to H gives 100% by weight.

The composition of the invention comprises, as component A, at least one linear or branched polyorganosiloxane comprising at least two alkenyl or alkynyl groups.

It is preferable that the composition of the invention comprises, as component A, at least one linear polyorganosiloxane comprising at least two alkenyl groups. The alkenyl groups are preferably vinyl groups, particularly preferably terminal vinyl groups.

One preferred embodiment of the composition of the invention comprises, as component A, at least one linear polyorganosiloxane of the general formula (IV)

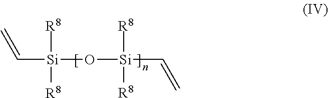

where

R⁸ is selected independently from C₁-C₆-alkyl; and

n is a number from 6 to 1000.

One particularly preferred embodiment of the composition of the invention comprises, as component A, at least one linear polyorganosiloxane of the general formula (IV), where R⁸ is methyl and n is a number from 6 to 1000.

The expression “C₁-C₆-alkyl” comprises the following group of alkyl groups: methyl, ethyl, n-propyl, isopropyl, n-butyl, isobutyl, sec-butyl, tert-butyl, n-pentyl, 3-methylbutyl, 2-methylbutyl, 1-nnethylbutyl, 1-ethylpropyl, n-hexyl, 4-methylpentyl, 3-methylpentyl, 2-methylpentyl, 1-methylpentyl, 2-ethylbutyl, 1-ethylbutyl, 1,1-dimethylbutyl, 1,2-dimethyl butyl, 1,3-dimethylbutyl, 2,2-dimethylbutyl, 2,3-dimethylbutyl, 3,3-dimethyl butyl, 1,1,2-trinnethylpropyl, 1,2,2-trimethylpropyl, 1-ethyl-1-methyl propyl, 1-ethyl-2-methylpropyl.

The viscosity of the polyorganosiloxane according to component A is generally from 1 to 500,000 mPa·s, preferably from 100 to 100 000 mPa·s, particularly preferably from 100 to 10 000 mPa·s.

The composition of the invention comprises from 30 to 99.799989% by weight, preferably from 50 to 99.69899% by weight, of component A.

The composition of the invention comprises, as component B, at least one linear or branched polyorganosiloxane comprising at least 3 Si—H groups.

It is preferable that the composition of the invention comprises, as component B, at least one linear polyorganosiloxane comprising at least 3 Si—H groups.

It is particularly preferable that the composition of the invention comprises, as component B, at least one linear polydimethylsiloxane comprising at least 3 Si—H groups.

The Si—H content of the polyorganosiloxane according to component B is generally from 0.5 to 20 mmol/g, preferably from 1 to 10 mmol/g, particularly preferably from 1 to 8 mmol/g, in particular from 4 to 8 mmol/g.

It is very particularly preferable that the composition of the invention comprises, as component B, at least one linear polydimethylsiloxane comprising at least 3 Si—H groups where the Si—H content of the polydimethylsiloxane is from 4 to 8 mmol/g.

The viscosity of the polyorganosiloxane according to component B is generally from 1 to 10,000 mPa·s, preferably from 1 to 1000 mPa·s, particularly preferably from 5 to 100 mPa·s.

The composition of the invention comprises from 0.1 to 30% by weight, preferably from 0.2 to 15% by weight, particularly preferably from 0.2 to 10% by weight, of component B.

The composition of the invention comprises, as component C, at least one hydrosilylation catalyst selected from the group consisting of the platinum-1,3-divinyl-1,1,3,3-tetramethyldisiloxane complex (Karstedt complex), the platinum-1,3-diallyl-1,1,3,3-tetramethyldisiloxane complex, the platinum-1,3-divinyl-1,3-dimethyl-1,3-diphenyldisiloxane complex, the platinum-1,1,3,3-tetraphenyldisiloxane complex, and the platinum-1,3,5,7-tetramethyl-1,3,5,7-tetravinylcyclotetrasiloxane complex. It is very particularly preferable that the hydrosilylation catalyst is the platinum-1,3-divinyl-1,1,3,3-tetramethyldisiloxane complex (Karstedt complex).

The composition of the invention comprises from 0.000001 to 1% by weight, preferably from 0.00001 to 1% by weight, particularly preferably from 0.0001 to 0.5% by weight, of component C.

The form in which component C is generally used is that of solution in the siloxane that forms the ligands of the platinum-siloxane complex. The solution generally comprises quantities of from 0.1 to 10% by weight of the platinum-siloxane complex.

The compounds tetramethyldivinylsiloxane, trimethyltrivinylcyclotrisiloxane and tetramethyltetravinylcyclotetrasiloxane are depicted below:

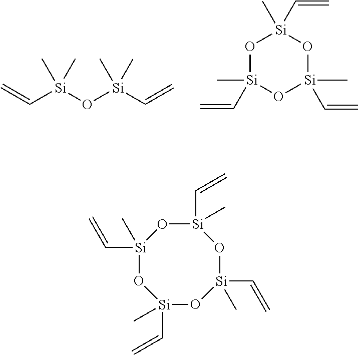

Preferred hydrosilylation catalyst is the platinum-1,3-divinyl-1,1,3,3-tetramethyldisiloxane complex (Karstedt complex). This is believed to have the following structure:

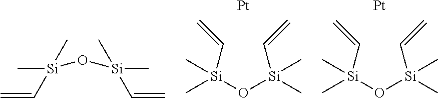

The composition of the invention comprises, as component D, tris(2,4-di-tert-butylphenyl) phosphite, as temporary inhibitor.

The composition of the invention comprises from 0.000001 to 5% by weight, preferably from 0.0001 to 0.5% by weight, particularly preferably from 0.001 to 0.05% by weight, of component D.

The activity of the catalyst can be controlled via the concentration of component D.

The composition of the invention comprises, as optional component E, an optionally coated inorganic filler. Examples of suitable inorganic fillers are dolomite, aluminium hydroxide, aluminium oxide, calcium carbonate, magnesium carbonate, glass fragments, fumed silica, and powdered quartz.

The composition of the invention comprises from 0 to 69.899989% by weight, preferably from 0.1 to 69.899989% by weight, preferably from 1 to 49.798999% by weight, particularly preferably from 10 to 49.798999% by weight, of component E.

The composition of the invention optionally comprises one or more linear or branched polyorganosiloxanes comprising two terminal Si—H groups, or one terminal Si—H group and one terminal alkenyl group, as component F.

It is preferable that component F is one or more linear polyorganosiloxanes comprising two terminal Si—H groups, or one terminal Si—H group and one terminal alkenyl group.

In one preferred embodiment component F is one or more polyorganosiloxanes of the general formula (II)

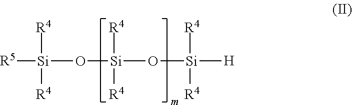

where

R⁴ is selected independently from C₁-C₆-alkyl;

R⁵ is selected from H and C₂-C₆-alkenyl; and

m is a number from 1 to 400.

R⁴ is preferably methyl.

R⁵ is preferably H or vinyl.

m is preferably a number from 2 to 400.

In one particularly preferred embodiment component F is one or more polyorgano-siloxanes of the general formula (II), where R⁴ is methyl, R⁵ is H or vinyl and m is a number from 2 to 400.

The expression “C₂-C₆-alkenyl” comprises the following group of alkenyl groups: vinyl, allyl, methallyl, 1-methylallyl, homoallyl, cis-but-2-enyl, trans-but-2-enyl, cis-pent-1-enyl, trans-pent-1-enyl, cis-pent-2-enyl, trans-pent-2-enyl, cis-pent-3-enyl, trans-pent-3-enyl, cis-1-methylbut-1-enyl, trans-1-methylbut-1-enyl, cis-2-methylbut-1-enyl, trans-2-methylbut-1-enyl, cis-3-methylbut-1-enyl, trans-3-methylbut-1-enyl, cis-1-methylbut-2-enyl, trans-1-methylbut-2-enyl, cis-2-methylbut-2-enyl, trans-2-methylbut-2-enyl, 3-methylbut-2-enyl, 1-methyl-but-3-enyl, 2-methylbut-3-enyl, 3-methylbut-3-enyl, cis-1-ethylprop-1-enyl, trans-1-ethylprop-1-enyl, 1-ethyl-prop-2-enyl, cis-hex-1-enyl, trans-hex-1-enyl, cis-hex-2-enyl, trans-hex-2-enyl, cis-hex-3-enyl, trans-hex-3-enyl, cis-hex-4-enyl, trans-hex-4-enyl, hex-5-enyl, cis-1-methylpent-1-enyl, trans-1-methylpent-1-enyl, cis-2-methylpent-1-enyl, trans-2-methylpent-1enyl, cis-3-methylpent-1-enyl, trans-3-methylpent-1-enyl, cis-4-methylpent-1-enyl, trans-4-methylpent-1-enyl, cis-1-methylpent-2-enyl, trans-1-methyl-pent-2-enyl, cis-2-methylpent-2-enyl, trans-2-methylpent-2enyl, cis-3-methylpent-2-enyl, trans-3-methylpent-2-enyl, cis-4-methylpent-2-enyl, trans-4-methylpent-2-enyl, cis-1-methylpent-3-enyl, trans-1-methylpent-3-enyl, cis-2-methylpent-3-enyl, trans-2-methyl-pent-3-enyl, cis-3-methylpent-3-enyl, trans-3-methylpent-3-enyl, 4-methylpent-3-enyl, 1-methylpent-4-enyl, 2-methylpent-4-enyl, 3-methylpent-4-enyl, 4-methylpent-4-enyl, cis-1,2-dimethylbut-1-enyl, trans-1,2-d imethylbut-1-enyl, cis-1, 3-dimethylbut-1-enyl, trans-1,3-dimethylbut-1-enyl, cis-3,3-dimethylbut-1-enyl, trans-3,3-dimethylbut-1-enyl, cis-1, 1-dimethylbut-2-enyl, trans-1, 1-dimethyl but-2-enyl, cis-1, 2-dimethyl but-2-enyl, trans-1,2-dimethylbut-2-enyl, cis-1,3-dimethylbut-2-enyl, trans-1,3-dimethylbut-2-enyl, cis-2,3-dimethylbut-2-enyl, trans-2,3-dimethylbut-2-enyl, 1,1-dimethylbut-3-enyl, 1,2-dimethylbut-3-enyl, 1,3-dimethylbut-3-enyl, 2,2-dimethylbut-3-enyl, 2,3-dimethylbut-3-enyl.

The viscosity of the polyorganosiloxane according to component F is generally from 1 to 10,000 mPa·s, preferably from 10 to 1000 mPa·s, particularly preferably from 10 to 50 mPa·s.

The composition of the invention comprises from 0 to 69.799989% by weight, preferably from 0 to 49.69899% by weight, particularly preferably from 0 to 19.5899% by weight, of component F.

One specific embodiment of the composition of the invention preferably comprises from 0 to 65.799989% by weight, particularly from 0 to 28.69899% by weight, very particularly from 0 to 17.0899% by weight, of component F.

One embodiment of the composition of the invention comprises 0% by weight of component F. Another embodiment of the composition of the invention comprises component F.

The composition of the invention optionally comprises one or more other linear or branched polyorganosiloxanes, as component G, different from components A, B, and where appropriate F.

In one embodiment component G is one or more linear polydimethylsiloxanes, preferably one or more polyorganosiloxanes of the general formula (III)

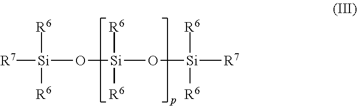

where

R⁶ is selected independently from C₁-C₆-alkyl;

R⁷ is selected independently from C₁-C₆-alkyl; and

p is a number from 1 to 2000.

R⁶ is preferably methyl.

R⁷ is preferably methyl.

p is preferably a number from 10 to 1000, in particular a number from 10 to 900.

In one particularly preferred embodiment component G is one or more polyorganosiloxanes of the general formula (II) where R⁶ is methyl, R⁷ is methyl and p is a number from 10 to 900.

The viscosity of the polyorganosiloxane according to component G is generally from 1 to 100,000 mPa·s, preferably from 10 to 10,000 mPa·s.

In another embodiment component G is organomonosilanes. Examples of preferred organomonosilanes are methacryloxypropyltrimethoxysilane and 3-glycidoxypropyltrimethoxysilane.

The composition of the invention comprises from 0 to 69.799989% by weight, preferably from 0 to 49.69899% by weight, particularly preferably from 0 to 19.5899% by weight, of component G.

One embodiment of the composition of the invention comprises 0% by weight of component G. Another embodiment of the composition of the invention comprises component G.

The composition of the invention optionally comprises one or more auxiliaries or additives as component H.

The additives according to component H are in particular conventional additives.

It is preferable that component H is one or more additives selected from the group consisting of pigments, dyes, adhesion promoters, flame retardants, UV stabilizers and UV fluorescence markers. The definition of component H also includes solvents used.

The additives comprise no tin salts and no peroxides.

The composition of the invention comprises from 0 to 10% by weight of component H.

Other embodiments of the composition of the invention also comprise, alongside components A to D and optionally E, one of components F, G and H, or two of components F, G and H (F and G or F and H or G and H) or all three components F, G and H.

The molar ratio of Si—H groups to Si-alkenyl groups in the composition of the invention is preferably in the range from 0.3 to 5, particularly preferably in the range from 0.3 to 2, very particularly preferably in the range from 0.3 to 1.5.

The shear viscosity of the composition of the invention is generally at most 100,000 mPa·s at a shear rate of 10 s⁻¹. It is preferable that the shear viscosity of the composition of the invention is at most 10,000 mPa·s at a shear rate of 10 s⁻¹.

For the purposes of the present invention the expression “viscosity” always means the dynamic viscosity (η), which has the unit N·s·m⁻²=Pa·s or mN·s·m⁻²=mPa·s.

The expression “shear viscosity” means the same as “viscosity”. The expression “shear viscosity” is in particular used instead of “viscosity” when the stated viscosity is based on a defined shear rate. This is then intended only to clarify that the viscosity changes as a function of the shear rate.

The viscosity can be determined by a wide variety of methods known to the person skilled in the art. By way of example, the dynamic viscosity can be determined with the aid of a capillary viscometer, a falling-ball viscometer or a rotary rheometer. A comprehensive description of viscosity determination is found in Meichsner, G./Mezger, T. a/SchrOder, J. (1997) Lackeigenschaften messen and steuern [Measurement and control of properties of coating materials] in Zorll, U. (Ed.), Rheometrie [Rheometry] (pp. 50-81). Hanover: Vincenz. Unless expressly otherwise stated, the viscosities mentioned in the present Application were determined in an oscillation/rotary rheometer (type: MCR-302 from Anton Paar).

Unless expressly otherwise stated, all of the viscosities mentioned in this Application are based on room temperature (23° C.).

The invention also provides a process for the application of a protective coating onto an electrical or electronic component or device, comprising the steps of:
a) provision of a composition of the invention;
b) application of the composition onto an electrical or electronic component or device; and
c) curing of the applied composition via heating, thus forming the protective coating.

The application according to step b) is generally achieved via conventional methods known to the person skilled in the art. Examples of such methods are encapsulation and vacuum encapsulation.

The curing according to step c) is achieved via heating, generally to a temperature of from 80 to 250° C. The heating is generally achieved via conventional methods known to the person skilled in the art. By way of example, an oven, or electromagnetic radiation, can be used.

It is preferable that the composition applied is cured at a temperature of from 80° C. to 250° C., particularly from 100° C. to 150° C.

The layer thickness of the protective coating applied by the process of the invention is generally from 0.01 to 30 cm, preferably from 0.1 to 30 cm.

The process of the invention is in particular suitable for the application of a protective coating to electrical or electronic components or devices which have long-term exposure to a temperature 150° C.

The process of the invention is in particular also suitable for the application of a protective coating to IGBTs (Insulated Gate Bipolar Transistors), control modules, circuit boards and semiconductors, in particular in the field of motor vehicle electronics and power electronics. The process of the invention can also be used for high-voltage applications.

The invention further provides the use of a composition of the invention for the application of a protective coating onto an electrical or electronic component or device.

The invention further provides an electrical or electronic component or device with, applied thereon, a protective coating, obtainable via the process of the invention.

The examples below provide further explanation of the invention.

### EXAMPLES

All parts data are parts by weight. A Speedmixer DAC 150.1 from Hauschild was used to mix the components. A TYP MCR 102 rheometer from Anton Paar was used for viscosity measurement at 25° C. Shore A hardness was measured with a commercially available Shore A measurement device. Penetration hardness was measured with a Petrotest PNR10 device.

### Example 1

290 parts of ground quartz, 10 parts of ground dolomite, 20 parts of a coated fumed silica, 630 parts of vinyl-terminated polydimethylsiloxane with viscosity 500 mPa·s and vinyl content 0.15 mmol/g, 30 parts of polyhydropolydimethylsiloxane with Si—H content 7 mmol/g, 2.5 parts of methacryloxypropyltrimethoxysilane and 2.5 parts of 3-glycidoxypropyltrimethoxysilane are mixed at 3500 revolutions for 2 minutes. This increased the temperature of the mixture. After cooling, 0.5 part of a 20% solution of tris(2,4-di-tert-butylphenyl) phosphite in xylene was added and the mixture was mixed at 3500 revolutions for 15 seconds. 0.6 part of a 1% solution of Karstedt complex in 1,3-divinyltetramethyldisiloxane was then added and the mixture was mixed at 3500 revolutions for 15 seconds.

The mixture was then stored for 6 months at room temperature. No significant viscosity rise was observed. Hardening is successful in 10 minutes at 120° C. The highest Shore A hardness is reached after 30 minutes at the said temperature.

### Example 2

430 parts of ground quartz, 4 parts of a fumed silica, 40 parts of ground calcium carbonate, 500 parts of vinyl-terminated polydimethylsiloxane with viscosity 200 mPa·s and vinyl content 0.25 mmol/g and 25 parts of polyhydropolydimethyl-siloxane with Si—H content 4 mmol/g are mixed at 3500 revolutions for 2 minutes. This increased the temperature of the mixture. After cooling, 0.5 part of a 20% solution of tris(2,4-di-tert-butylphenyl) phosphite in xylene was added and the mixture was mixed at 3500 revolutions for 15 seconds. 0.5 part of a 1% solution of Karstedt complex in 1,3-divinyltetramethyldisiloxane was then added and the mixture was mixed at 3500 revolutions for 15 seconds.

The mixture was then stored for 6 months at room temperature. No significant viscosity rise was observed. Hardening is successful in 10 minutes at 120° C. The highest Shore A hardness is reached after 30 minutes at the said temperature.

### Example 3

883 parts of vinyl-terminated polydimethylsiloxane with viscosity 800 mPa·s and vinyl content 0.20 mmol/g, 13 parts of polyhydropolydimethylsiloxane with Si—H content 7 mmol/g, 100 parts of a dihydropolydimethylsiloxane, 2.5 parts of methacryloxypropyltrimethoxysilane and 2.5 parts of 3-glycidoxypropyltrimethoxy-silane are mixed at 3500 revolutions for 2 minutes. This increased the temperature of the mixture. After cooling, 0.5 part of a 20% solution of tris(2,4-di-tert-butylphenyl) phosphite in xylene was added and the mixture was mixed at 3500 revolutions for 15 seconds. 0.5 part of a 1% solution of Karstedt complex in 1,3-divinyltetramethyldisiloxane was then added and the mixture was mixed at 3500 revolutions for 15 seconds.

The mixture was then stored for 6 months at room temperature. No significant viscosity rise was observed. Hardening is successful in 10 minutes at 120° C. The highest Shore A hardness is reached after 30 minutes at the said temperature.

### Example 4

966 parts of vinyl-terminated polydimethylsiloxane with viscosity 1000 mPa·s and vinyl content 0.12 mmol/g, 30 parts of polyhydropolydimethylsiloxane with Si—H content 0.9 mmol/g and 6 parts of polyhydropolydimethylsiloxane with Si—H content 4 mmol/g are mixed at 3500 revolutions for 2 minutes. This increased the temperature of the mixture. After cooling, 0.5 part of a 20% solution of tris(2,4-di-tert-butylphenyl) phosphite in xylene was added and the mixture was mixed at 3500 revolutions for 15 seconds. 0.5 part of a 1% solution of Karstedt complex in 1,3-divinyltetramethyldisiloxane was then added and the mixture was mixed at 3500 revolutions for 15 seconds.

The mixture was then stored for 6 months at room temperature. No significant viscosity rise was observed. Hardening is successful in 10 minutes at 120° C. The highest PEN hardness is reached after 30 minutes at the said temperature.

1. A composition comprising
a) from 30 to 99.799989% by weight of at least one linear or branched polyorganosiloxane comprising at least two alkenyl or alkynyl groups, as component A;
b) from 0.1 to 30% by weight of at least one linear or branched polyorganosiloxane comprising at least 3 Si—H groups, as component B;
c) from 0.000001 to 1% by weight of a hydrosilylation catalyst selected from the group consisting of a platinum-1,3-divinyl-1,1,3,3-tetramethyldisiloxane complex (Karstedt complex), a platinum-1,3-diallyl-1,1,3,3-tetramethyldisiloxane complex, a platinum-1,3-divinyl-1,3-dimethyl-1,3-diphenyldisiloxane complex, a platinum-1,1,3,3-tetraphenyldisiloxane complex, and a platinum-1,3,5,7-tetramethyl-1,3,5,7-tetravinylcyclotetrasiloxane complex, as component C;
d) from 0.00001 to 5% by weight of tris(2,4-di-tert-butylphenyl) phosphite as component D;
e) from 0 to 69.899989% by weight of at least one optionally coated filler as component E;
f) from 0 to 69.899989% by weight of one or more linear or branched poly-organosiloxanes comprising two terminal Si—H groups or one terminal Si—H group and one terminal alkenyl group, as component F;
g) from 0 to 69.799989% by weight of one or more other linear or branched polyorganosiloxanes as component G;
h) from 0 to 10% by weight of one or more additives as component H;
where the entirety of components A to H gives 100% by weight.

2. The composition according to claim 1, characterized in that the hydrosilylation catalyst is the platinum-1,3-divinyl-1,1,3,3-tetramethyldisiloxane complex (Karstedt complex).

3. The composition according to claim 1, characterized in that the composition comprises, as component A, at least one linear polyorganosiloxane of the general formula (IV) 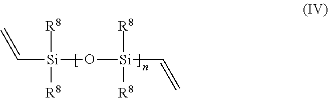
where
R⁸ is selected independently from C₁-C₆-alkyl; and
n is a number from 6 to 1000.

4. The composition according to claim 1, characterized in that the composition comprises, as component B, at least one linear polydimethylsiloxane comprising at least 3 Si—H groups, where the Si—H content of the polydimethylsiloxane is from 4 to 8 mmol/g.

5. The composition according to claim 1, characterized in that component F is one or more polyorganosiloxanes of the general formula (II) 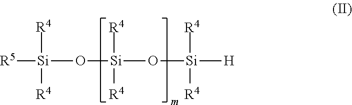
where
R⁴ is selected independently from C₁-C₆-alkyl;
R⁵ is selected from H and C₂-C₆-alkenyl; and
m is a number from 1 to 400.

6. The composition according to claim 1, characterized in that component G is one or more polyorganosiloxanes of the general formula (III) 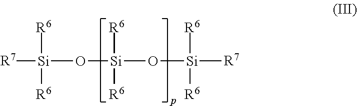
where
R⁶ is selected independently from C₁-C₆-alkyl;
R⁷ is selected independently from C₁-C₆-alkyl; and
p is a number from 1 to 2000.

7. A process for the application of a protective coating onto an electrical or electronic component or device, comprising:
a) providing a composition according to claim 1;
b) applying the composition onto an electrical or electronic component or device; and
c) curing the applied composition via heating, thus forming the protective coating.

8. (canceled)

9. An electrical or electronic component or device with, applied thereon, a protective coating, obtained via the process according to claim 7.
